(19) United States
(12) Patent Application Publication
(10) Pub. No.: US 2021/0115359 A1
(43) Pub. Date: Apr. 22, 2021

(54) DETERGENT COMPOSITION

(71) Applicant: KAO CORPORATION, Tokyo (JP)

(72) Inventors: Tomohiko NAGANO, Izumiotsu-shi, Osaka (JP); Teruyuki FUKUDA, Wakayama-shi, Wakayama (JP); Takahiro MAEDA, Wakayama-shi, Wakayama (JP)

(73) Assignee: KAO CORPORATION, Tokyo (JP)

(21) Appl. No.: 16/981,850

(22) PCT Filed: Mar. 13, 2019
(86) PCT No.: PCT/JP2019/010367

§ 371 Date: Sep. 17, 2020

(30) Foreign Application Priority Data
Mar. 28, 2018 (JP) 2018-063234

(51) Int. Cl. C11D 3/30; C11D 3/43; C11D 11/00

(52) U.S. Cl. CPC C11D 3/30; C11D 11/0058; C11D 11/0029; C11D 3/43

(57) ABSTRACT

The present invention relates to a cleaning agent composition having an excellent cleaning power against a hard surface to which a polymer is adhered even under a room temperature condition, and provides [1] a cleaning agent composition containing a water-soluble organic amine (a), an alkylamine oxide (b) represented by the following general formula (1), an organic solvent (c) having a Hansen solubility parameter (HSP value) of 15 to 19.5 as measured at 20° C., and water; and [2] a method of cleaning a heard surface, including the step of cleaning the hard surface using the aforementioned cleaning agent composition at a temperature of not lower than 45° C. and not higher than 85° C.;

(R¹)(R²)(R³)N→O (1)

wherein R¹ and R² are each independently an alkyl group or alkenyl group having 1 to 3 carbon atoms, and R³ is an alkyl group or alkenyl group having 8 to 16 carbon atoms.

### FIELD OF THE INVENTION

The present invention relates to a cleaning agent composition and a method for cleaning a hard surface using the cleaning agent composition.

### BACKGROUND OF THE INVENTION

On a hard surface such as an inner wall surface of a reaction vessel, etc., in which a polymer is used or which are used in a process for production of the polymer, after discharging the polymer used or produced therein, the high-viscous or cured polymer such as typically the residual polymer, residues of various inorganic and/or organic additives added to the polymer and further a high-viscous or cured polymer mixture formed by mixing the polymer and additives, etc., tend to remain adhered thereto (the aforementioned polymer, residues and polymer mixture are hereinafter also collectively referred to merely as “polymers, etc.”).

In the case of repeatedly using the hard surface to which the polymer tends to be adhered, as in the aforementioned reaction vessel, it is necessary that the hard surface is cleaned to remove the polymers, etc., adhered thereto after each time of using the reaction vessel or before the next use of the reaction vessel.

For example, in the application field of production of a water dispersion for ink-jet printing, the water dispersion is generally obtained by using a polymer dispersion containing a polymer as a main component and a colorant constituted of a pigment or a dye as well as, if required, various additives. However, upon producing the water dispersion, polymer-like deposits tend to be fixedly retained onto an inner wall of a production apparatus including a reaction vessel, etc., in a gas-liquid interface to a solvent used for production of the water dispersion. When changing the kind of water dispersion produced therein to the other, etc., the inner wall of the production apparatus or the reaction vessel is to be cleaned. However, if the amount of the polymer-like deposits fixedly retained on the inner wall surface is increased, the polymer-like deposits tend to be included and mixed in the water dispersion, so that the resulting water-based ink containing the water dispersion tends to be deteriorated in a performance thereof. In addition, in the inks for ink-jet printing, it is known that the polymer is subjected to crosslinking treatment in order to obtain an ink having low viscosity and high optical density. However, the polymer subjected to the crosslinking treatment tends to be hardly removed by cleaning works using conventional cleaning agents. For this reason, it is an important task to provide a cleaning method for removing the polymers, etc., adhered onto the hard surface of the reaction vessel, etc.

JP 2000-127419A (Patent Literature 1) discloses a cleaning method in which after conducting printing operation using a pigment-containing ink composition, nozzles of an ink-jet print head are cleaned using a cleaning solution that contains a surfactant, a basic compound and water and has a pH value of not less than 9.

JP 2012-67152A (Patent Literature 2) discloses a method of cleaning a hard surface using a water-based cleaning agent at a cleaning temperature of 45 to 85° C., in which the water-based cleaning agent contains (a) an alkali agent, (b) an alkylamine oxide and (c) an organic solvent having a solubility parameter of 8 to 12 (cal/cm³)^{1/2}, and has a pH value of 11 to 14.

JP 2016-60156A (Patent Literature 3) discloses a cleaning solution for cleaning portions of an ink-jet printer to which an aqueous ink ejected tends to be adhered, which contains an amphoteric surfactant, a basic compound and water, and has a pH value of 9 to 12, in which the amp hoteric surfactant such as dimethyl laurylamine oxide, etc., is contained in an amount of 0.1 to 3% by mass on the basis of a whole amount of the cleaning solution.

### SUMMARY OF THE INVENTION

The present invention relates to a cleaning agent composition containing a water-soluble organic amine (a), an alkylamine oxide (b) represented by the following general formula (1), an organic solvent (c) having a Hansen solubility parameter (HSP value) of not less than 15 and not more than 19.5 as measured at 20° C., and water:

(R¹)(R²)(R³)N→O (1)

wherein R¹ and R² are each independently an alkyl group or alkenyl group having not less than 1 and not more than 3 carbon atoms, and R³ is an alkyl group or alkenyl group having not less than 8 and not more than 16 carbon atoms.

### DETAILED DESCRIPTION OF THE INVENTION

The cleaning methods and cleaning solutions described in the aforementioned Patent Literatures 1 to 3 have failed to attain a fully satisfactory effect of cleaning a hard surface to which polymers, etc., are adhered.

The present invention relates to a cleaning agent composition that is capable of exhibiting an excellent cleaning power against a hard surface, especially a hard surface to which polymers are adhered, in particular, against such a hard surface as constituting a production line for production of an ink for ink-jet printing, even when used under room temperature conditions, and a method of cleaning a hard surface using the cleaning agent composition.

The present inventors have found that when using a specific cleaning agent composition containing a water-soluble organic amine, an alkylamine oxide and an organic solvent, it is possible to effectively clean a hard surface.

That is, the present invention relates to the following aspects [1] and [2].
[1] A cleaning agent composition containing a water-soluble organic amine (a), an alkylamine oxide (b) represented by the following general formula (1), an organic solvent (c) having a Hansen solubility parameter (HSP value) of not less than 15 and not more than 19.5 as measured at 20° C., and water:

(R¹)(R²)(R³)N→O (1)

wherein R¹ and R² are each independently an alkyl group or alkenyl group having not less than 1 and not more than 3 carbon atoms, and R³ is an alkyl group or alkenyl group having not less than 8 and not more than 16 carbon atoms.
[2] A method of cleaning a heard surface, including the step of cleaning the hard surface using the aforementioned cleaning agent composition at a temperature of not lower than 0° C. and not higher than 50° C.

In accordance with the present invention, it is possible to provide a cleaning agent composition that is capable of exhibiting an excellent cleaning power against a hard surface, especially a hard surface to which especially polymers are adhered, in particular, against such a hard surface as constituting a production line for production of of an ink for ink-jet printing, even when used under room temperature conditions, and a method of cleaning a hard surface using the cleaning agent composition.

### [Cleaning Agent Composition]

The cleaning agent composition of the present invention is characterized in that the composition contains a water-soluble organic amine (a), an alkylamine oxide (b) represented by the following general formula (1) (hereinafter also referred to merely as an “alkylamine oxide (b)”), an organic solvent (c) having a Hansen solubility parameter (HSP value) of not less than 15 and not more than 19.5 as measured at 20° C. (hereinafter also referred to merely as an “organic solvent (0”), and water:

(R¹)(R²)(R³)N→O (1)

wherein R¹ and R² are each independently an alkyl group or alkenyl group having not less than 1 and not more than 3 carbon atoms, and R³ is an alkyl group or alkenyl group having not less than 8 and not more than 16 carbon atoms.

In accordance with the cleaning agent composition of the present invention, it is possible to effectively clean especially a hard surface to which polymers, etc., as a material to be removed by cleaning are adhered, even when used under room temperature conditions.

The hard surface is preferably a surface of a member which is brought into contact with polymers, etc. As such a member, there may be mentioned, for example, a wide range of objects constituting a production line in which polymers are used or produced, such as those members formed of metals, glass, potteries, plastics, etc. Among these members, especially preferred are metal objects that have high alkali resistance and hardly suffer from temperature-dependent deformation. More specifically, the hard surface is preferably a surface of a metal member which is brought into contact with polymers, etc. As a metal material of such a metal member, preferred are iron and stainless steel, and more preferred is stainless steel.

As the material to be removed by cleaning using the cleaning agent composition of the present invention, there may be mentioned deposits of polymers, etc., which tend to be formed upon use of the polymers or upon production of the polymers. The polymers, etc., are not particularly limited.

Specific examples of the hard surface as the object to be cleaned include inner wall surfaces of reaction vessels, etc., in apparatuses used in a production line in which deposition of polymers tend to be caused at a high frequency, e.g., a production line in which addition polymerization-based polymers such as vinyl-based polymers such as styrene-acrylic copolymers, polycondensation-based polymers such as polyesters or polyethylene terephthalate, polyurethanes, etc., ring opening polymerization-based polymers such as epoxy resins, and the like are used, or a production line in which the aforementioned polymers are synthesized. In particular, such a hard surface to which crosslinked polymers, low-acid value polymers (for example, polyesters and the like), etc., are adhered, tends to be hardly cleaned by the conventionally known cleaning agents.

The cleaning agent composition of the present invention can be applied to a hard surface to which polymers, etc., are adhered, for example, in a production line for a water-based ink for ink-jet printing, in particular, in a production line for a water dispersion including the step of forming raw material components containing a polymer into particles in a water-based medium. In this case, the material fixedly retained on the hard surface of the reaction vessel as a material to be removed by cleaning is mainly constituted of polymer-like deposits fixedly retained in a gas-liquid interface to a solvent used for production of the water dispersion. The polymer-like deposits are constituted of raw material components such as polymers and unreacted monomers as raw materials of polymers which are used for production of the below-mentioned water dispersion, and various additives such as a colorant, a surfactant and the like. The polymer-like deposits contain the polymers as a main component thereof.

In the following, the respective components of the cleaning agent composition of the present invention, etc., are explained.

<Water-Soluble Organic Amine (a)>

The cleaning agent composition of the present invention contains the water-soluble organic amine (a) from the viewpoint of improving a cleaning power of the composition against a hard surface.

The term “water-soluble” as used herein means that the organic amine has a solubility in water of not less than 5 g/100 gH₂O and preferably not less than 10 g/100 gH₂O as measured by dissolving the organic amine in 100 g of water at 25° C.

The number of carbon atoms of the water-soluble organic amine (a) is preferably not less than 2 and more preferably not less than 3, and is also preferably not more than 10, more preferably not more than 8 and even more preferably not more than 6, from the viewpoint of improving a cleaning power of the composition against a hard surface.

The acid dissociation constant pKa of the water-soluble organic amine (a) as measured in an aqueous solution thereof at 25° C. is preferably not less than 9.0, more preferably not less than 9.2 and even more preferably not less than 9.5 from the viewpoint of improving a cleaning power of the composition against a hard surface.

Examples of the water-soluble organic amine (a) include alkanolamines, alkylamines, aralkylamines, polyamines, cyclic amines and the like. Among these amines, from the viewpoint of improving cleaning properties of the composition, preferred are alkanolamines.

As the alkanolamines, there may be used any of primary alkanolamines, secondary alkanolamines and tertiary alkanolamines.

Specific examples of the primary alkanolamines include monoethanolamine, monopropanolamine, monoisopropanolamine, monobutanolamine and the like.

Specific examples of the secondary alkanolamines include N-methyl ethanolamine, N- ethyl ethanolamine, N-propyl ethanolamine, N-butyl ethanolamine, diethanolamine, diisopropanolamine, N- methyl propanolamine, N-methyl isopropanolamine, N-ethyl isopropanolamine, N-propyl isopropanolamine and the like.

Specific examples of the tertiary alkanolamines include N,N-dimethyl ethanolamine, N,N-dimethyl propanolamine, NN-diethyl ethanolamine, Methyl diethanolamine, N- methyl diethanolamine, triethanolamine (p Ka: 7.72), triisopropanolamine and the like.

Among these water-soluble organic amines, preferred are those water-soluble alkanolamines having not less than 2 and not more than 8 carbon atoms; more preferred is at least one alkanolamine selected from the group consisting of the primary alkanolamines and the secondary alkanolamines; and even more preferred is at least one alkanolamine selected from the group consisting of monoethanolamine (pKa; 9.44), monoisopropanolamine (pKa; 9.45), N-methyl ethanolamine (pKa; 9.99), N-ethyl ethanolamine (pKa; 9.9), diethanolamine (pKa; 8.88), diisopropanolamine (pKa; 8.84), N-methyl isopropanolamine, N,N-dimethyl ethanolamine (pKa; 9.22), N,N-diethyl ethanolamine (pKa; 9.75) and N-methyl diethanolamine (pKa; 8.56).

From the viewpoint of improving cleaning properties of the composition as well as from the viewpoint of improving versatility of the composition, as the water-soluble organic amine (a), further eve more preferred is at least one alkanolamine selected from the group consisting of monoethanolamine, diethanolamine and N-methyl ethanolamine.

Incidentally, the solubility in water of the aforementioned alkanolamines as the preferred examples of the water-soluble organic amine (a) is not less than 50 g/100 gH₂O as measured by dissolving the respective alkanolamines in 100 g of water at 25° C.

The aforementioned various water-soluble organic amines (a) may be used alone or in combination of any two or more thereof.

<Alkylamine Oxide (b) represented by General Formula (1)>

The cleaning agent composition of the present invention contains the alkylamine oxide (b) from the viewpoint of improving a cleaning power of the composition against a hard surface. By incorporating the alkylamine oxide (b) into the cleaning agent composition, it is possible to not only enhance adhesion of the cleaning agent composition to the hard surface, but also improve uniform wet-spreadability of the cleaning agent composition over a whole portion of the hard surface. In addition, the cleaning agent composition can exhibit good foaming properties and can also be improved in rinsing properties.

The alkylamine oxide (b) contained in the cleaning agent composition of the present invention is represented by the following general formula (1):

(R¹)(R²)(R³)N→O (1).

In the general formula (1), R¹ and R² are each independently an alkyl group or alkenyl group having not less than 1 and not more than 3 carbon atoms. As R¹ and R², from the viewpoint of improving cleaning properties of the composition when repeatedly using the composition plural times, preferred is a methyl group or an ethyl group, and more preferred is a methyl group. In the present invention, by using the specific alkylamine oxide, it is possible to allow the composition to exhibit peculiar cleaning properties.

In addition, R³ represents an alkyl group or alkenyl group having not less than 8 and not more than 16 carbon atoms. As R³, from the viewpoint of improving cleaning properties of the composition when repeatedly using the composition plural times, preferred is a linear or branched alkyl group or alkenyl group having not less than 8 and not more than 14 carbon atoms, and more preferred is a linear or branched alkyl group having not less than 8 and not more than 14 carbon atoms.

Specific examples of the compound represented by the general formula (1) include at least one compound selected from the group consisting of lauryl dimethylamine oxide, lauryl diethylamine oxide, myristyl dimethylamine oxide and cocoalkylamine oxides. Among these compounds, preferred is at least one compound selected from the group consisting of lauryl dimethylamine oxide and lauryl diethylamine oxide.

The aforementioned alkylamine oxides (b) may be used alone or in combination of any two or more thereof.

<Organic Solvent (c) having Hansen Solubility Parameter of not less than 15 and not more than 19.5>

The cleaning agent composition of the present invention contains the organic solvent (c) having a Hansen solubility parameter (HSP value) of not less than 15 and not more than 19.5 as measured at 20° C. The unit of the Hansen solubility parameter (HSP value) is ((J/cm³)^{1/2}), and the unit of the HSP value is ((J/cm³)^{1/2}) unless otherwise noted.

The HSP value is constituted of three individual parameter values obtained by dividing a solubility parameter (SP value) introduced by Hildebrand into three energy components (an energy item δ_{d} due to an intermolecular dispersion force, an energy item δₚ due to an intermolecular dipole interaction and an energy item δₕ due to an intermolecular hydrogen bond). The details of δ_{d}, δₚ and δₕ of the respective solvents are described more specifically in “HANSEN SOLUBILITY PARAMETERS”, A User's Handbook, Second Edition. In addition, the HSP values of many solvents or resins are also described in Wesley L. Archer, “Industrial Solvents Handbook”, etc.

In the case where the organic solvent (c) used herein contains a plurality of organic solvents, the HSP value of the organic solvent (c) may be determined as a weighted mean value m of HSP values of the respective organic solvents according to the following formula (2).

m=δ₁ϕ₁+δ₂ϕ₂ (2)

wherein δ₁ and δ₂ are HSP values of the respective solvent components; and ϕ₁ and ϕ₂ are volume fractions of the respective solvent components.

The HSP value of the organic solvent may also be determined using a software HSPiP available from Charles Hansen Consulting, Inc., (Horsholm, Denmark, hansen-solubility.com).

In the present invention, with respect to the solvents registered in the data base of HSPiP version 4.1.03 (refer to various literatures concerning the HSP values), there are used the HSP values described therein, whereas with respect to the solvents not appearing in any data base, there are used the HSP values estimated by the aforementioned HSPiP.

When the HSP value is less than 15 or more than 19.5, the organic solvent tends to be deteriorated in compatibility with polymers, etc., as contaminants, and therefore the resulting cleaning agent composition tends to be deteriorated in cleaning properties. The SP value of the organic solvent is preferably not less than 15.5, more preferably not less than 16.0, even more preferably not less than 16.5 and further even more preferably not less than 17.0, and is also preferably not more than 19.4.

In addition, the organic solvent (c) is preferably at least one compound selected from the group consisting of a compound containing an ether group such as a cyclic ether, a chain-like ether, etc., a compound containing an ester group such as an acetic acid ester, etc., and a compound containing a ketone group such as a chain-like ketone, etc.

Suitable examples of the organic solvent whose HSP value is not less than 15 and not more than 19.5 as a single solvent include at least one solvent selected from the group consisting of cyclic ether solvents such as tetrahydrofuran (HSP value: 19.46), etc.; chain-like ether solvents such as diethyl ether (HSP value: 15.49), etc.; acetic acid ester solvents such as ethyl acetate (HSP value: 18.15), isopropyl acetate (HSP value: 17.59), propyl acetate (HSP value: 17.62), butyl acetate (HSP value: 17.41), etc.; chain-like ketone solvents such as methyl ethyl ketone (HSP value: 19.05), methyl propyl ketone (HSP value: 18.33), methyl isobutyl ketone (HSP value: 16.97), diisobutyl ketone (HSP value: 16.93), etc.; and the like. Among these organic solvents, preferred are chain-like ketone solvents, and more preferred is methyl ethyl ketone.

These organic solvents may be used alone or in combination of any two or more thereof.

In addition to the organic solvent whose HSP value is not less than 15 and not more than 19.5 as a single solvent, a plurality of organic solvents may also be used in combination with each other in the from of a mixed solvent as long as the HSP value of the mixed solvent as the value m in the aforementioned formula (2) lies within the range of not less than 15 and not more than 19.5. For example, in the case where methyl ethyl ketone (HSP value: 19.05) and cyclohexanone (HSP value: 20.33) as a cyclic ketone are used as a mixed solvent in combination with each other at volume fractions of 80% and 20%, respectively, the value m is equal to 19.31 (m =19.31). Therefore, the mixed solvent can be used as the organic solvent (c) whose HSP value is not less than 15 and not more than 19.5.

### <Other Additives>

The cleaning agent composition of the present invention may also contain various known additives such as a nonionic surfactant, a chelating agent, a solubilizing agent, a slurrying agent, a defoaming agent, etc., unless the objects and advantageous effects of the present invention are adversely affected by inclusion thereof.

As the nonionic surfactant, from the viewpoint of improving cleaning properties of the composition for removing deposits of polymers, etc., on the hard surface, preferred is a nonionic surfactant having a HLB value of from 4.3 to 8.2 as measured by a Davies method. The HLB value of the nonionic surfactant is more preferably from 5 to 7.9, and even more preferably from 5.7 to 7.5.

Examples of commercially available products of the nonionic surfactant usable in the present invention include “BLAUNON EH-2”, “BLAUNON EH-4”, “BLAUNON EH-6” and “BLAUNON EH-11” all available from Aoki Oil Industrial Co., Ltd.; “EMULGEN 109P”, “EMULGEN 120”, “SOFTANOL EP9050” and “SOFTANOL EP12030” all available from Kao Corporation; “SOFTANOL 90”, “SOFTANOL 120”, “SOFTANOL 150” and “SOFTANOL 200” all available from Nippon Shokubai Co., Ltd.; and the like.

The chelating agent is capable of enhancing a cleaning effect of removing polymers, etc., on a hard surface.

From the viewpoint of improving cleaning properties of the composition for removing polymers, etc., on the hard surface, examples of the suitable chelating agent include alkali metal salts or lower amine salts of gluconic acid, glucoheptonic acid, ethylenediaminetetraacetic acid, citric acid, malic acid and hydroxyethylidene diphosphonic acid, and the like. Among these chelating agents, more preferred are sodium gluconate, sodium glucoheptonate, sodium ethylenediaminetetraacetate, sodium citrate, sodium hydroxyethylidene diphosphonate, and the like.

In addition, in the case where the cleaning agent composition is in the form of a concentrated solution, in order to maintain the composition in the state of a stable aqueous solution that is free of phase separation or crystallization of components thereof, the cleaning agent composition preferably contains a solubilizing agent, and it is also preferred that the composition further contains a slurrying agent, if required, to ensure flowability of the concentrated system.

Examples of the solubilizing agent include C₆ to C₁₈ alkenyl-succinic acids and salts thereof, as well as hexanoic acid, heptanoic acid, octanoic acid, decanoic acid, lauric acid, butyric acid, valeric acid, isobutyric acid, 2-ethyl-hexanoic acid, salts of these acids, and the like.

Examples of the slurrying agent include water-soluble polymer carboxylic acids, naphthalenedicarboxylic acids, alkali metal salts or amine salts of these acids, and the like.

### <Cleaning Agent Composition>

The cleaning agent composition of the present invention contains the water-soluble organic amine (a), the alkylamine oxide (b) represented by the general formula (1), the organic solvent (c) having an HSP value of not less than 15 and not more than 19.5 as measured at 20° C., and water.

The contents of the respective components in the cleaning agent composition of the present invention may be appropriately controlled depending upon kinds of materials to be removed by cleaning or kinds of contaminants, and preferably fall within the following ranges from the viewpoint of improving a cleaning power of the composition for removing polymers, etc., adhered onto the hard surface.

The content of the water-soluble organic amine (a) in the cleaning agent composition is preferably not less than 0.05% by weight, more preferably not less than 0.1% by weight, even more preferably not less than 0.5% by weight and further even more preferably not less than 1% by weight, and is also preferably not more than 12% by weight, more preferably not more than 10% by weight, even more preferably not more than 8% by weight and further even more preferably not more than 5% by weight.

The content of the alkylamine oxide (b) in the cleaning agent composition is preferably not less than 0.01% by weight, more preferably not less than 0.05% by weight, even more preferably not less than 0.1% by weight and further even more preferably not less than 0.5% by weight, and is also preferably not more than 10% by weight, more preferably not more than 5% by weight, even more preferably not more than 3% by weight and further even more preferably not more than 2% by weight.

The content of the organic solvent (c) in the cleaning agent composition is preferably not less than 1% by weight, more preferably not less than 2% by weight, even more preferably not less than 5% by weight and further even more preferably not less than 10% by weight, and is also preferably not more than 45% by weight, more preferably not more than 40% by weight, even more preferably not more than 35% by weight and further even more preferably not more than 30% by weight.

The content of water such as deionized water, distilled water, etc., in the cleaning agent composition is preferably not less than 30% by weight, more preferably not less than 40% by weight and even more preferably not less than 50% by weight, and is also preferably not more than 95% by weight, more preferably not more than 90% by weight and even more preferably not more than 85% by weight.

In the case where the solubilizing agent is used in the cleaning agent composition, from the viewpoint of improving low-temperature stability of the resulting cleaning agent and cost efficiency, the content of the solubilizing agent in the cleaning agent composition is preferably from 0.01 to 3% by weight and more preferably from 0.05 to 1% by weight.

The mass ratio of the water-soluble organic amine (a) to the alkylamine oxide (b) [(a)/(b)] in the cleaning agent composition is preferably not less than 0.1, more preferably not less than 1, even more preferably not less than 2, further even more preferably not less than 3 and still further even more preferably not less than 4, and is also preferably not more than 50, more preferably not more than 35, even more preferably not more than 20 and further even more preferably not more than 10.

The mass ratio of the organic solvent (c) to the alkylamine oxide (b) [(c)/(b)] in the cleaning agent composition is preferably not less than 10, more preferably not less than 15, even more preferably not less than 20 and further even more preferably not less than 25, and is also preferably not more than 300, more preferably not more than 270, even more preferably not more than 250 and further even more preferably not more than 200.

The viscosity of the cleaning agent composition as measured at 32° C. is preferably not less than 1 mPa·s, more preferably not less than 1.1 mPa·s and even more preferably not less than 1.2 mPa·s, and is also preferably not more than 8 mPa·s, more preferably not more than 6 mPa·s, even more preferably not more than 4 mPa·s and further even more preferably not more than 2 mPa·s, from the viewpoint of improving a cleaning power of the composition for removing polymers, etc., adhered onto the hard surface.

The static surface tension of the cleaning agent composition is preferably not less than 18 mN/m, more preferably not less than 20 mN/m, even more preferably not less than 22 mN/m and further even more preferably not less than 25 mN/m, and is also preferably not more than 45 mN/m, more preferably not more than 40 mN/m, even more preferably not more than 35 mN/m and further even more preferably not more than 32 mN/m, from the viewpoint of improving a cleaning power of the composition for removing polymers, etc., adhered onto the hard surface.

The pH value of the cleaning agent composition as measured at 20° C. is preferably not less than 9, more preferably not less than 9.5, even more preferably not less than 10 and further even more preferably not less than 11, and is also preferably not more than 14, more preferably not more than 13 and even more preferably not more than 12, from the viewpoint of improving a cleaning power of the composition for removing polymers, etc., adhered onto the hard surface.

The viscosity, static surface tension and pH value of the cleaning agent composition may be measured by the respective methods described in Examples below.

### [Method of Cleaning Hard Surface]

The method of cleaning a heard surface according to the present invention is characterized by including the step of cleaning the hard surface using the cleaning agent composition of the present invention at a temperature near to room temperature, i.e., at a temperature of not lower than 0° C. and not higher than 50° C. The method of cleaning a heard surface according to the present invention is simple and useful because no special treatment such as heating of the hard surface, etc., is needed.

As described above, the hard surface is preferably a surface of a metal member which is brought into contact with polymers, etc., and more preferably a surface of a member constituting a production line used in the step of forming components containing polymers, etc., into particles in a water-based medium.

In the cleaning method of the present invention, the hard surface to which polymers, etc., are adhered, is preferably maintained in the temperature range of not lower than 0° C. and more preferably not lower than 10° C., and from the viewpoint of saving energy consumed, the hard surface is also preferably maintained in the temperature range of not higher than 50° C., more preferably not higher than 45° C. and even more preferably not higher than 42° C. The cleaning agent composition can exhibit an excellent cleaning effect when the cleaning temperature of the hard surface is maintained in the aforementioned temperature range.

The cleaning operation used in the cleaning method of the present invention is not particularly limited. For example, any of ordinary cleaning operations such as immersion cleaning, agitation cleaning, spray cleaning, brush cleaning, etc., may be used in the present invention. When the hard surface is cleaned preferably while intentionally foaming the cleaning agent composition of the present invention by agitation cleaning, spray cleaning, brush cleaning, etc., it is possible to attain a higher cleaning effect on the hard surface.

In addition, in the cleaning method of the present invention, after using the cleaning agent composition of the present invention, it is possible to separately store the cleaning agent composition in a storage facility such as a tank, a drum can, etc., for reuse thereof, so that the cleaning agent composition can be repeatedly used plural times. Accordingly, it is desirable that the cleaning agent composition can continuously exhibit its cleaning effect even after once storing the cleaning agent composition used. The cleaning agent composition of the present invention has high stain resistance and is excellent in storage performance, and therefore can be repeatedly used usually not less than 5 times, preferably not less than 8 times and more preferably not less than 10 times against the hard surface to which polymers, etc., are adhered.

### <Material to be Removed by Cleaning and Apparatus to be Cleaned>

In the cleaning agent composition and the method of cleaning a hard surface according to the present invention, as the material to be removed by cleaning, there may be mentioned polymers. From the viewpoint of exhibiting a good cleaning power of the composition, the polymers are preferably water-insoluble polymers. The apparatuses or facilities to which the cleaning agent composition of the present invention and the method of cleaning a hard surface according to the present invention can be applied are not particularly limited. Examples of the apparatus to be cleaned include those apparatuses and facilities such as a reaction vessel for producing the polymers, a mixing vessel in which the polymers are compounded, a conduit for transporting a liquid containing the polymers, a storage facility for storing a liquid containing the polymers, and the like. Also, the cleaning agent composition and the cleaning method according to the present invention can be applied to cleaning of a printer using a water dispersion for ink-jet printing or an ink for ink-jet printing, an equipment for maintenance of the printer and an ink-jet printing system, etc.

For example, in the case where the cleaning agent composition and the method of cleaning a hard surface according to the present invention is used to clean a water dispersion production apparatus including a hard surface to which a material to be removed by cleaning is adhered, after at least the hard surface is cleaned by the cleaning agent composition and the cleaning method according to the present invention, the raw material components containing the polymers can be formed into particles in a water-based medium to produce the water dispersion.

As the water dispersion production apparatus, there may be used production apparatuses of various scales including a small-scale production apparatus of such a level as used in a laboratory through a large-scale production apparatus for mass production. More specifically, as the production apparatus, there may be employed various reaction vessels including a small-capacity reaction vessel having a capacity of about 200 L through a large-capacity reaction vessel having a capacity of 10 m³, further a capacity of 20 m³ and furthermore a capacity of more than 20 m³.

As the aforementioned reaction vessel, there can be suitably used such reaction vessels as mentioned as to the aforementioned hard surface. For example, there may be used those reaction vessels described in JP 9-258479A, more specifically, there may be suitably used those reactors including a glass-lined reactor whose surface is provided with a glass lining, a reactor having a conductive surface, typically a reactor formed of an anti-corrosive metal such as stainless steel, etc., and various materials.

The polymers used upon cleaning the production facility of a water dispersion, in particular, a water dispersion for ink-jet printing, or a water-based ink for ink-jet printing, are not particularly limited.

In the present invention, it is preferred that after cleaning the apparatus or facility using the cleaning agent composition, the water dispersion for ink-jet printing is produced by the below-mentioned production method. In addition, the water-based ink can be obtained by adding an organic solvent and water to the resulting water dispersion to appropriately control a concentration of the water dispersion, followed, if required, by further adding additives that are usually used in water-based inks, such as a wetting agent, etc., to the water dispersion.

### <Polymers>

Examples of the material to be removed by cleaning include water-insoluble polymers. Specific examples of the water-insoluble polymers include polyesters, vinyl polymers such as polystyrene and polyvinyl chloride, urethane polymers, and the like.

For example, as the polymers used for production of the aforementioned water dispersion and water-based ink, from the viewpoint of atomizing a colorant such as a pigment, etc., to improve dispersibility and storage stability of the water dispersion and water-based ink as well as from the viewpoint of enhancing optical density and adhesion to a printing medium (hereinafter also referred to merely as a “substrate adhesion properties”) of the water-based ink obtained from the water dispersion, there are preferably used water-insoluble polymers such as polyesters, vinyl polymers, etc. In addition, the polymers may also be used as a fixing resin that serves as a film-forming agent for the water-based ink.

The terms “water-insoluble polymer” and “water-soluble polymer” as used therein are defined as follows. That is, in the case where the polymer contains a salt-forming group, the salt-forming group of the polymer is neutralized 100% with acetic acid or sodium hydroxide according to the kind of salt-forming group, and 100 g of pure water maintained at 25° C. is added to 10 g of the resulting neutralized polymer, followed by sufficiently stirring the resulting mixture. In this case, if the polymer is completely dissolved in the pure water, the polymer is regarded as being the “water-soluble polymer” defined in the present invention.

For example, a 100% neutralized product of a solution prepared by previously dissolving the polymer in an organic solvent such as methyl ethyl ketone, etc., is added dropwise to pure water, and the organic solvent is removed from the resulting mixed solution to obtain a water dispersion having a concentration of 10% by weight, followed by subjecting the resulting water dispersion to centrifugal separation to separate the dispersion into respective components. In this case, the precipitated polymer is defined as a “water-insoluble polymer”, whereas the dissolved polymer is defined as a “water-soluble polymer”.

### <Water-Insoluble Polymer>

Typical examples of the preferred water-insoluble polymer include polyesters, vinyl polymers, urethane polymers and the like.

### [Polyester]

The polyester is preferably such a polyester as obtained by subjecting at least (i) an alcohol component and (ii) a carboxylic acid component to polycondensation reaction.

### (i) Alcohol Component

The alcohol component from which a constitutional unit of the polyester is derived preferably includes an aromatic diol from the viewpoint of improving dispersibility, etc., of the pigment in the resulting water-based ink.

The aromatic diol is preferably an alkyleneoxide adduct of bisphenol A. Incidentally, the alkyleneoxide adduct of bisphenol A as used in the present invention means a whole structure of a compound formed by adding oxyalkylene groups to 2,2-bis(4-hydroxyphenyl)propane.

Specific examples of the preferred alkyleneoxide adduct of bisphenol A includes those compounds represented by the following general formula (I).

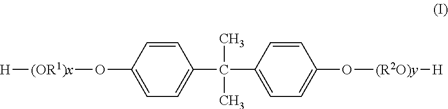

In the general formula (I), OR¹ and R²O are respectively an oxyalkylene group, an are each independently preferably an oxyalkylene group having not less than 1 and not more than 4 carbon atoms, and more preferably an oxyethylene group or an oxypropylene group.

The suffixes x and y each correspond to a molar number of addition of an alkyleneoxide, and are each independently preferably not less than 1 and more preferably not less than 2, and also preferably not more than 16, more preferably not more than 7, even more preferably not more than 5 and further even more preferably not more than 3. Moreover, from the viewpoint of attaining good reactivity with the carboxylic acid component, an average value of a sum of x and y is preferably not less than 2. In addition, from the same viewpoint as described above, the average value of a sum of x and y is is also preferably not more than 7, more preferably not more than 5 and even more preferably not more than 3.

Furthermore, the OR¹ groups in the number of x and the R²O groups in the number of y may be respectively the same or different from each other. From the viewpoints of improving substrate adhesion properties of the resulting ink, the R¹O groups and the R²O groups are respectively preferably identical to each other. These alkyleneoxide adducts of bisphenol A may be used alone or in combination of any two or more thereof. As the alkyleneoxide adduct of bisphenol A, preferred are a propyleneoxide adduct of bisphenol A and an ethyleneoxide adduct of bisphenol A, and more preferred is a propyleneoxide adduct of bisphenol A.

The content of the alkyleneoxide adduct of bisphenol A in the aforementioned alcohol component as a raw material monomer of the polyester is preferably not less than 50 mol %, more preferably not less than 60 mol % and even more preferably not less than 70 mol %, and is also preferably not more than 100 mol %, from the viewpoints of improving substrate adhesion properties of the resulting ink.

The alcohol component as the raw material monomer of the polyester may also contain the following other alcohol components in addition to the alkyleneoxide adduct of bisphenol A.

Examples of the other alcohol components include ethylene glycol, propylene glycol, glycerin, pentaerythritol, trimethylolpropane, hydrogenated bisphenol A, sorbitol, and alkylene (having not less than 2 and not more than 4 carbon atoms) oxide adducts of these compounds (average molar number of addition of the alkyleneoxide: not less than 1 and not more than 16), and the like.

These alcohol components may be used alone or in combination of any two or more thereof.

### (ii) Carboxylic Acid Component

The carboxylic acid component from which a constitutional unit of the polyester is derived includes carboxylic acids, anhydrides of the carboxylic acids, alkyl (having not less than 1 and not more than 3 carbon atoms) esters of the carboxylic acids, and the like.

Examples of the preferred carboxylic acid component include aromatic dicarboxylic acids, aliphatic dicarboxylic acids, alicyclic dicarboxylic acids and trivalent or higher-valent polycarboxylic acids. Among these carboxylic acids, from the viewpoint of improving reactivity between the carboxylic acid component and the alcohol component as well as from the viewpoint of improving substrate adhesion properties of the resulting ink, more preferred are aromatic dicarboxylic acids and aliphatic dicarboxylic acids, and even more preferred are aliphatic dicarboxylic acids.

Examples of the preferred aromatic dicarboxylic acids include phthalic acid, isophthalic acid and terephthalic acid. Of these aromatic dicarboxylic acids, more preferred is terephthalic acid.

Examples of the aliphatic dicarboxylic acids include unsaturated aliphatic dicarboxylic acids and saturated aliphatic dicarboxylic acids. Among these aliphatic dicarboxylic acids, from the viewpoint of improving reactivity between the carboxylic acid component and the alcohol component as well as from the viewpoint of improving substrate adhesion properties of the resulting ink, preferred are unsaturated aliphatic dicarboxylic acids.

As the unsaturated aliphatic dicarboxylic acids, preferred are fumaric acid and maleic acid, and more preferred is fumaric acid. As the saturated aliphatic dicarboxylic acids, preferred are adipic acid and succinic acid (the succinic acid may be substituted with an alkyl group and/or an alkenyl group).

Examples of the preferred alicyclic dicarboxylic acids include cyclohexanedicarboxylic acid, decalinedicarboxylic acid and tetrahydrophthalic acid.

Examples of the preferred trivalent or higher-valent polycarboxylic acids include trimellitic acid and pyromellitic acid.

The aforementioned carboxylic acid components may be used alone or in combination of any two or more thereof.

### (Production of Polyester)

The polyester may be produced, for example, by subjecting the aforementioned alcohol component and carboxylic acid component to polycondensation reaction in an inert gas atmosphere at a temperature of not lower than 180° C. and not higher than 250° C., if required in the presence of an esterification catalyst.

In the case where the obtained polyester is used in the form of resin particles, from the viewpoint of well controlling a particle size of the resin particles, it is preferred that the polyester has a sharp molecular weight distribution, and the polyester is preferably produced by polycondensation reaction using the esterification catalyst.

Examples of the esterification catalyst include tin catalysts, titanium catalysts, metal compounds such as antimony trioxide, zinc acetate, germanium dioxide, etc., and the like. Among these esterification catalysts, from the viewpoint of improving reaction efficiency of the esterification reaction upon production of the polyester, preferred are tin catalysts. Specific examples of the tin catalysts preferably used herein include dibutyl tin oxide, tin (II) di(2-ethyl hexanoate) and salts of these compounds, and the like. Among these tin catalysts, more preferred is tin (II) di(2-ethyl hexanoate).

Also, if required, an esterification co-catalyst such as 3,4,5-trihydroxybenzoic acid, etc., may be further used in the esterification reaction. In addition, a radical polymerization inhibitor such as 4- tert-butyl catechol, hydroquinone, etc., may also be used in combination with the esterification catalyst or the like.

The softening point of the obtained polyester is preferably not lower than 80° C., more preferably not lower than 85° C. and even more preferably not lower than 90° C., and is also preferably not higher than 170° C., more preferably not higher than 145° C. and even more preferably not higher than 125° C., from the viewpoint of improving substrate adhesion properties of the resulting ink.

The glass transition temperature (Tg) of the obtained polyester is preferably not lower than 50° C. and more preferably not lower than 55° C., and is also preferably not higher than 95° C., more preferably not higher than 90° C., even more preferably not higher than 85° C. and further even more preferably not higher than 80° C., from the viewpoint of improving substrate adhesion properties of the resulting ink.

The acid value of the obtained polyester is preferably not less than 5 mgKOH/g, more preferably not less than 15 mgKOH/g and even more preferably not less than 20 mgKOH/g, and is also preferably not more than 40 mgKOH/g, more preferably not more than 37 mgKOH/g and even more preferably not more than 35 mgKOH/g, from the viewpoint of well controlling a particle size of the resin particles as well as from the viewpoint of improving substrate adhesion properties of the resulting ink.

The weight-average molecular weight (Mw) of the obtained polyester is preferably not less than 5,000, more preferably not less than 7,500 and even more preferably not less than 10,000, and is also preferably not more than 100,000, more preferably not more than 50,000 and even more preferably not more than 30,000, from the viewpoint of improving solvent resistance, dispersion stability, etc., of the resulting ink.

### [Vinyl Polymer]

The vinyl polymer preferably contains at least one constitutional unit selected from the group consisting of a constitutional unit derived from (a) an ionic monomer, a constitutional unit derived from (b) a hydrophobic monomer and a constitutional unit derived from (c) a hydrophilic nonionic monomer, more preferably contains two or more constitutional units among these three constitutional units, and even more preferably contains all of these three constitutional units, from the viewpoint of improving dispersion stability of the pigment-containing polymer particles in the resulting water-based ink. Examples of a combination of these monomers include a combination of the ionic monomer (a) and the hydrophobic monomer (b) and a combination of the ionic monomer (a), the hydrophobic monomer (b) and the hydrophilic nonionic monomer (c).

The vinyl polymer may be obtained, for example, by subjecting a monomer mixture containing the ionic monomer (a), the hydrophobic monomer (b) and the hydrophilic nonionic monomer (c) to addition polymerization by conventionally known methods.

### (a) Ionic Monomer

Examples of the ionic monomer (a) (hereinafter also referred to merely as a “component (a)”) include an anionic monomer and a cationic monomer. Among these ionic monomers, preferred is an anionic monomer.

Examples of the anionic monomer include a carboxylic acid monomer, a sulfonic acid monomer, a phosphoric acid monomer, etc.

Among the aforementioned anionic monomers, from the viewpoint of improving dispersion stability of the pigment-containing polymer particles in the resulting water-based ink, preferred is a carboxy group-containing carboxylic acid monomer, more preferred are acrylic acid, methacrylic acid, crotonic acid, itaconic acid, maleic acid, fumaric acid, citraconic acid, 2-methacryloyloxymethylsuccinic acid, etc., and even more preferred is at least one monomer selected from the group consisting of acrylic acid and methacrylic acid.

Examples of the cationic monomer include N,N-dimethylaminoethyl methacrylate, N,N-dimethylaminoethyl acrylamide, etc.

Meanwhile, the ionic monomer (a) may also include those monomers that have no ionicity under neutral conditions, but are converted into ions under acid or alkaline conditions, such as acids, amines, etc.

### (b) Hydrophobic Monomer

Examples of the hydrophobic monomer (b) (hereinafter also referred to merely as a “component (b)”) include an alkyl (meth)acrylate, an aromatic group-containing monomer, etc.

The alkyl (meth)acrylate preferably include those alkyl (meth)acrylates containing an alkyl group having 1 to 22 carbon atoms and preferably 6 to 18 carbon atoms. Examples of the alkyl (meth)acrylate include methyl (meth) acrylate, ethyl (meth) acrylate, (iso)propyl (meth)acrylate, (iso- or tert-)butyl (meth) acrylate, (iso)amyl (meth)acrylate, cyclohexyl (meth) acrylate, 2-ethylhexyl (meth)acrylate, (iso)octyl (meth) acrylate, (iso)decyl (meth) acrylate, (iso)dodecyl (meth) acrylate, (iso)stearyl (meth) acrylate, etc.

Meanwhile, the terms “(iso- or tert-)” and “(iso)” as used herein mean both of the structure in which any of the groups expressed by “iso- or tert-” and “iso” is present, and the structure in which any of these groups is not present (i.e., normal). In addition, the term “(meth)acrylate” as used herein means an acrylate and/or a methacrylate.

The aromatic group-containing monomer is preferably in the form of a vinyl monomer containing an aromatic group having 6 to 22 carbon atoms, and more preferably a styrene-based monomer, an aromatic group-containing (meth)acrylate and a styrene-based macromonomer.

As the styrene-based monomer, preferred are styrene, 2-methyl styrene and divinyl benzene, and more preferred is styrene. In addition, as the aromatic group-containing (meth) acrylate, preferred are benzyl (meth) acrylate, phenoxyethyl (meth)acrylate, etc., and more preferred is benzyl (meth)acrylate.

The styrene-based macromonomer is in the form of a compound containing a polymerizable functional group at one terminal end thereof and having a number-average molecular weight of preferably not less than 500 and more preferably not less than 1,000, and also preferably not more than 100,000 and more preferably not more than 10,000. The polymerizable functional group is preferably an acryloyloxy group or a methacryloyloxy group, and more preferably a methacryloyloxy group.

Specific examples of the styrene-based macromonomer include “AS-6(S)”, “AN-6(S)” and “HS-6(S)” (tradenames) all available from Toagosei Co., Ltd., etc.

### (c) Hydrophilic Nonionic Monomer

Examples of the hydrophilic nonionic monomer (c) (hereinafter also referred to merely as a “component (c)”) include 2-hydroxyethyl (meth)acrylate, 3-hydroxypropyl (meth)acrylate, a polyalkylene glycol (meth)acrylate such as polypropylene glycol (n=2 to 30 in which n represents an average molar number of addition of oxyalkylene groups: hereinafter defined in the same way) (meth)acrylate, polyethylene glycol (n=2 to 30) (meth) acrylate, etc., an alkoxy polyalkylene glycol (meth)acrylate such as methoxy polyethylene glycol (n=1 to 30) (meth)acrylate, octoxy polyethylene glycol (n=1 to 30) (meth)acrylate, etc., phenoxy (ethylene glycol/propylene glycol copolymer) (n=1 to 30 in which n for ethylene glycol: n=1 to 29) (meth)acrylate, and the like.

Specific examples of commercially available products of the component (c) include “NK ESTER M-20G”, “NK ESTER M-40G”, “NK ESTER M-90G”, “NK ESTER M-230G” and the like as products available from Shin-Nakamura Chemical Co., Ltd.; and “BLEMMER PE-90”, “BLEMMER PE-200”, “BLEMMER PE-350” and the like, “BLEMMER PME-100”, “BLEMMER PME-200”, “BLEMMER PME-400” and the like, “BLEMMER PP-500”, “BLEMMER PP-800”, “BLEMMER PP-1000” and the like, “BLEMMER AP-150”, “BLEMMER AP-400”, “BLEMMER AP-550” and the like, and “BLEMMER 50PEP-300”, “BLEMMER 50POEP-800B”, “BLEMMER 43PAPE-600B” and the like as products available from NOF Corporation.

The aforementioned components (a) to (c) may be respectively used alone or in the form of a mixture of any two or more thereof.

The vinyl polymer may also contain a constitutional unit(s) derived from the other monomer(s) in addition to the constitutional units derived from the aforementioned components.

### (Contents of Respective Components or Respective Constitutional Units in Vinyl Polymer)

The contents of the constitutional units derived from the respective components in the vinyl polymer are as follows from the viewpoint of improving dispersion stability of the pigment-containing polymer particles in the resulting water-based ink.

The content of the ionic monomer (a) is preferably not less than 3% by mass, more preferably not less than 5% by mass and even more preferably not less than 8% by mass, and is also preferably not more than 60% by mass, more preferably not more than 50% by mass and even more preferably not more than 40% by mass.

The content of the hydrophobic monomer (b) is preferably not less than 20% by mass, more preferably not less than 40% by mass and even more preferably not less than 50% by mass, and is also preferably not more than 90% by mass, more preferably not more than 80% by mass and even more preferably not more than 75% by mass.

In the case where the hydrophilic nonionic monomer (c) is included, the content of the hydrophilic nonionic monomer (c) is preferably not less than 5% by mass, more preferably not less than 10% by mass and even more preferably not more than 20% by mass, and is also preferably not more than 60% by mass, more preferably not more than 55% by mass and even more preferably not more than 50% by mass.

In addition, in the case where the macromonomer is included as the component (b), the content of the macromonomer is preferably not less than 5% by mass, more preferably not less than 8% by mass and even more preferably not more than 10% by mass, and is also preferably not more than 50% by mass, more preferably not more than 40% by mass and even more preferably not more than 30% by mass.

Furthermore, the mass ratio of the ionic monomer (a) to the hydrophobic monomer (b) including the macromonomer [(a)/(b)] is preferably not less than 0.01, more preferably not less than 0.05 and even more preferably not less than 0.10, and is also preferably not more than 1, more preferably not more than 0.60 and even more preferably not more than 0.50.

### (Production of Vinyl Polymer)

The aforementioned vinyl polymer may be produced by copolymerizing the monomer mixture by known polymerization methods. As the polymerization methods, preferred is a solution polymerization method.

The organic solvent used in the solution polymerization method is preferably an organic polar solvent. If the organic polar solvent is miscible with water, the organic polar solvent may be used in the form of a mixture with water. Examples of the preferred organic polar solvent include aliphatic alcohols having 1 to 3 carbon atoms; ketones having 3 to 8 carbon atoms; and a mixed solvent of at least one of these compounds with water.

The polymerization may be carried out in the presence of a known radical polymerization initiator such as azo compounds, organic peroxides, etc. The amount of the radical polymerization initiator used in the polymerization is preferably from 0.01 to 2 mol per 1 mol of the monomer mixture.

The polymerization conditions for polymerization of the monomer mixture may vary depending upon the kinds of radical polymerization initiator, monomers, solvents and the like used in the polymerization reaction, and therefore are not particularly limited. In general, the polymerization temperature is preferably from 50 to 80° C., and the polymerization time is preferably from 1 to 20 hours. In addition, the polymerization is preferably conducted in an inert gas atmosphere such as a nitrogen gas atmosphere, etc.

The vinyl polymer is preferably directly used as such in the form of a polymer solution without removing the solvent used in the polymerization reaction therefrom from the viewpoint of enhancing productivity of the water dispersion of the pigment-containing polymer particles.

The solid content of the polymer solution is preferably not less than 30% by mass and more preferably not less than 40% by mass, and is also preferably not more than 70% by mass and more preferably not more than 65% by mass, from the viewpoint of enhancing productivity of the water dispersion of the pigment-containing polymer particles.

The weight-average molecular weight of the polymer is preferably not less than 8,000, more preferably not less than 10,000 and even more preferably not less than 11,000, and is also preferably not more than 500,000, more preferably not more than 300,000 and even more preferably not more than 100,000, from the viewpoint of improving dispersion stability of the resulting ink. Incidentally, the weight-average molecular weight may be measured by the method described in Examples below.

Specific examples of commercially available products of the vinyl polymer include polyacrylic acids such as “ARON AC-10SL” available from Toagosei Co., Ltd., etc., and styrene-acrylic resins such as “JONCRYL 67”, “JONCRYL 611”, “JONCRYL 678”, “JONCRYL 680”, “JONCRYL 690” and “JONCRYL 819” all available from BASF Japan, Ltd., etc., and the like.

The pigment used in the water dispersion and the water-based ink is not particularly limited, and may be either an organic pigment, an inorganic pigment or a mixture thereof.

The solid content of the resulting pigment water dispersion (concentration of non-volatile components in the pigment water dispersion) is preferably from 10 to 30% by mass and more preferably from 15 to 25% by mass from the viewpoint of improving dispersion stability of the pigment water dispersion as well as from the viewpoint of facilitating preparation of the water-based ink.

The solid content of the pigment water dispersion may be measured by the method described in Examples below.

The average particle size of the pigment-containing polymer particles in the pigment water dispersion is preferably from 50 to 200 nm, more preferably from 60 to 190 nm and even more preferably from 80 to 180 nm from the viewpoint of suppressing formation of coarse particles as well as from the viewpoint of improving ejection stability of the resulting water-based ink.

The average particle size of the pigment-containing polymer particles may be measured by the method described in Examples below.

In addition, the average particle size of the pigment-containing polymer particles in the water-based ink is the same as the average particle size of the pigment-containing polymer particles in the pigment water dispersion. Moreover, the preferred range of the average particle size of the pigment-containing polymer particles in the water-based ink is also the same as the preferred range of the average particle size of the pigment-containing polymer particles in the pigment water dispersion.

### <Water Dispersion for Ink-Jet Printing>

The water dispersion for ink-jet printing may be produced using a water dispersion production apparatus having a hard surface to which polymers, etc., are adhered, by cleaning at least the hard surface by the cleaning agent composition and the cleaning method of the present invention, followed by atomizing raw material components containing the polymer in a water-based medium.

The content of the polymer in the water dispersion is preferably from 1 to 20% by weight, more preferably from 2 to 15% by weight and even more preferably from 3 to 10% by weight from the viewpoint of improving optical density and storage stability of the water-based ink containing the water dispersion.

The content of the colorant in the water dispersion is preferably from 1 to 30% by weight, more preferably from 2 to 25% by weight, even more preferably from 4 to 20% by weight and further even more preferably from 5 to 15% by weight from the sane viewpoint as described above.

The content of water in the water dispersion is preferably from 30 to 95% by weight, more preferably from 40 to 90% by weight and even more preferably from 50 to 80% by weight.

### [Water-Based Ink for Ink-Jet Printing]

The water-based ink for ink-jet printing may be produced by adding and mixing an organic solvent and water, if required, into the water dispersion obtained by the aforementioned method. The water-based ink may be further compounded with various additives that may be usually used in water-based inks, such as a latex emulsion, a wetting agent, a penetrant, a dispersant, a defoaming agent, an antiseptic agent, etc.

The content of the polymer in the water-based ink is preferably from 1 to 20% by weight, more preferably from 2 to 15% by weight and even more preferably from 3 to 10% by weight from the viewpoint of improving optical density and storage stability of the water-based ink.

The content of the colorant in the water-based ink is preferably from 1 to 25% by weight, more preferably from 2 to 20% by weight, even more preferably from 3 to 18% by weight and further even more preferably from 4 to 15% by weight from the viewpoint of enhancing optical density of the ink.

The content of water in the water-based ink is preferably from 20 to 90% by weight, more preferably from 30 to 80% by weight and even more preferably from 40 to 70% by weight.

The viscosity of the water-based ink as measured at 32° C. is preferably from 2 to 12 mPa·s, more preferably from 3 to 9 mPa·s and even more preferably from 4 to 8 mPa·s from the viewpoint of improving storage stability, etc., of the water-based ink.

### EXAMPLES

In the following Production Examples, Preparation Examples, Examples and Comparative Examples, the “part(s)” and “%” indicate “part(s) by mass” and “% by mass”, respectively, unless otherwise specified. Meanwhile, various properties of the cleaning agent composition and the polymers were measured by the following methods.

### <Measurement of Properties of Cleaning Agent Composition>

(1) Viscosity of Cleaning Agent Composition

The viscosity of the cleaning agent composition was measured at 32° C. using an E-type viscometer “TV-25” (equipped with a standard cone rotor 1° 34′×R24; rotating speed: 50 rpm) available from Toki Sangyo Co., Ltd.
(2) Static Surface Tension of Cleaning Agent Composition

A platinum plate was dipped in 5 g of a sample adjusted to 20° C. which was filled in a cylindrical polyethylene container (3.6 cm in diameter×1.2 cm in depth), and the static surface tension of the sample was measured at 20° C. using a surface tension meter “CBVP-Z” available from Kyowa Interface Science Co., Ltd., by a Wilhelmy method.
(3) pH of Cleaning Agent Composition

The pH value of the cleaning agent composition was measured at 20° C. using a pH meter “F-23” (tradename) available from Horiba Ltd., according to JIS Z8802.

### <Measurement of Properties of Polyester>

(1) Softening Point of Polyester

Using a flow tester “CFT-500D” available from Shimadzu Corporation, 1 g of a sample to be measured was extruded through a nozzle having a die pore diameter of 1 mm and a length of 1 mm while heating the sample at a temperature rise rate of 6° C/minute and applying a load of 1.96 MPa thereto by a plunger. The softening point of the sample was determined as the temperature at which a half amount of the sample was flowed out when plotting a downward movement of the plunger of the flow tester relative to the temperature.
(2) Glass Transition Temperature of Polyester

Using a differential scanning calorimeter “Pyris 6 DSC” (tradename) commercially available from PerkinElmer Co., Ltd., a sample to be measured was heated to 200° C. and then cooled from 200° C. to 0° C. at a temperature drop rate of 10° C./minute, and thereafter the sample thus cooled was heated again at a temperature rise rate of 10° C./minute to prepare an endothermic characteristic curve thereof. The temperature at which an extension of a baseline below an endothermic maximum peak temperature on the curve was intersected with a tangential line having a maximum inclination of the curve in the range of from a rise-up portion to an apex of the peak was read as a glass transition temperature of the sample.

Meanwhile, in the case were the sample was in the form of polymer particles in a water dispersion, the water dispersion was freeze-dried at −10° C. for 9 hours using a freeze dryer “FDU-2100” available from Tokyo Rika Kikai Co., Ltd., and the thus obtained freeze-dried product was used as the sample.

### (3) Acid Value of Polyester

The acid value of the polyester was measured by the same neutralization titration method as prescribed in JIS K 0070-1992 except that a mixed solvent of ethanol and ether used as a measuring solvent in the method was replaced with a mixed solvent containing acetone and toluene at a volume ratio [acetone: toluene] of 1:1.

### (4) Weight-Average Molecular Weights (Mw) of Polyester

A polymer to be measured was dissolved in chloroform to prepare a solution of the polymer having a concentration of 0.5 g/100 mL. Next, the resulting solution was subjected to filtration treatment by passing through a fluororesin filter “FP-200” having a pore size of 2 μm available from Sumitomo Electric Industries, Ltd., to remove insoluble components therefrom, thereby preparing a sample solution.

Tetrahydrofuran as an eluent was allowed to flow through analytical columns at a flow rate of 1 mL/minute, and the columns were stabilized in a thermostat at 40° C. One hundred microliters (100 μL) of the sample solution were injected into the columns to measure a molecular weight of the sample. The weight-average molecular weight of the sample was calculated on the basis of a calibration curve previously prepared.

The calibration curve of the molecular weight was prepared by using several kinds of monodisperse polystyrenes (monodisperse polystyrenes having weight-average molecular weights (Mw) of 2.63×10³, 2.06×10⁴ and 1.02×10⁵ all available from Tosoh Corporation as well as monodisperse polystyrenes having weight-average molecular weights (Mw) of 2.10×10³, 7.00×10³ and 5.04×10⁴ all available from GL. Sciences Inc., as reference standard samples.
Measuring Apparatus: “CO-8010” available from Tosoh Corporation
Analytical Columns: “GMHXL”+“G3000HXL” both available from Tosoh 20 Corporation

### <Measurement of Properties of Vinyl Polymer>

(1) Acid Value of Vinyl Polymer

Two grams of the vinyl polymer or 2 g of a pigment water dispersion containing the crosslinked vinyl polymer were diluted with 50 g of ion-exchanged water, and then mixed with 3 mL of a 0.1 N sodium hydroxide solution. Then, a 0.1 N hydrochloric acid was gradually added dropwise to the resulting solution to measure two inflection points in a titration curve of a pH value thereof. The number of moles of the acid calculated from the difference between amounts (titers) of the 0.1 N hydrochloric acid added dropwise which were measured at the two inflection points corresponds to the number of moles of carboxylic acid groups in the polymer. The thus determined number of moles of the carboxylic acid groups in the polymer was converted into an acid value thereof.
(2) Weight-Average Molecular Weight (Mw) of Vinyl Polymer

The weight-average molecular weight of the vinyl polymer was measured by gel chromatography [GPC apparatus: “HLC-8120GPC” available from Tosoh Corporation; columns: “TSK-GEL, a-M” x 2 available from Tosoh Corporation; flow rate: 1 mL/min] using a solution prepared by dissolving phosphoric acid and lithium bromide in N,N-dimethylformamide such that concentrations of phosphoric acid and lithium bromide in the resulting solution were 60 mmol/L and 50 mmol/L, respectively, as an eluent, and using monodisperse polystyrenes having previously known molecular weights as a reference standard substance.

### <Others>

(1) Solid Content of Pigment Water Dispersion

Sodium sulfate dried to constant weight in a desiccator was weighed in an amount of 10.0 g and charged into a 30 mL polypropylene container (inner diameter: 40 mm; height: 30 mm), and 1.0 g of a sample to be measured was added to the container. The contents of the container were mixed with each other, and then the weight of the resulting mixture was measured. The mixture was maintained in the container at 105° C. for 2 hours to remove volatile components therefrom, and further allowed to stand in a desiccator for 15 minutes to measure a mass of the mixture after removing the volatile components therefrom. The value obtained by subtracting the mass of the sodium sulfate from the mass of the mixture after removing the volatile components therefrom was regarded as a mass of solid components of the sample after removing volatile components therefrom. The solid content (% by mass) of the sample was calculated by dividing the mass of the solid components by the mass of the sample before removing the volatile components therefrom.
(2) Average Particle Size of Pigment-Containing (Crosslinked) Polymer Particles

The dispersion of the pigment⁻containing (crosslinked) polymer particles was subjected to cumulant analysis using a laser particle analyzing system “ELSZ-1000” available from Otsuka Electrics Co., Ltd., to measure an average particle size of the particles. The measurement was conducted under the conditions including a temperature of 25° C., an angle between incident light and detector of 165° and a cumulative number of 100 times, and a refractive index of water (1.333) was input to the analyzing system as a refractive index of the dispersing medium. The concentration of the dispersion to be measured was adjusted to 5×10⁻³% by mass in terms of a solid content thereof. The thus determined cumulant average particle size was defined as the average particle size of the pigment-containing (crosslinked) polymer particles.

### Production Example A1 (Production of Polyester PA-1)

A 10 L-capacity four-necked flask equipped with a thermometer, a stirring device, a flow-down type condenser and a nitrogen inlet tube was charged with 3718 g of polyoxypropylene (2.2)-2,2-bis(4-hydroxyphenyl)propane as an alcohol component, 1282 g of fumaric acid, 25 g of tin (II) di(2-ethyl hexanoate) as an esterification catalyst and 0.25 g of 3,4,5-trihydroxybenzoic acid as an esterification co-catalyst, and the contents of the flask were reacted at 210° C. in a nitrogen atmosphere in a mantle heater for 10 hours, and then the reaction was further continued until a softening point of the resulting polymer as measured under −8.3 kPa (G) reached 100.9° C., thereby obtaining a polyester.

The softening point, glass transition temperature, acid value and weight-average molecular weight of the thus obtained polyester were 100.9° C., 58.5° C., 22.4 mgKOH/g and 13700, respectively.

### Production Example A2 (Production of Polyester PA-2)

A 10 L-capacity four-necked flask equipped with a thermometer, a stirring device, a flow-down type condenser and a nitrogen inlet tube was charged with 5740 g of polyoxypropylene (2.2)-2,2-bis(4-hydroxyphenyl)propane as an alcohol component, 1633 g of terephthalic acid, 571 g of fumaric acid, 378 g of trimellitic anhydride and 40 g of tin (II) di(2-ethyl hexanoate) as an esterification catalyst, and the contents of the flask were reacted at 210° C. in a nitrogen atmosphere in a mantle heater for 10 hours, and then the reaction was further continued until a softening point of the resulting polymer as measured under −8.3 kPa (G) reached 122° C., thereby obtaining a polyester.

The softening point, glass transition temperature, acid value and weight-average molecular weight of the thus obtained polyester were 122° C., 72° C., 31 mgKOH/g and 20700, respectively.

### Preparation Example A1 (Preparation of Water Dispersion A-I of Pigment-Containing Polyester Particles A-1 as Contaminants)

(1) Step 1

In a 2 L-capacity container, 66.7 g of the polyester PA-1 was dissolved in 156.4 g of methyl ethyl ketone (MEK). The obtained solution was mixed with 5.36 g of a 5N sodium hydroxide aqueous solution as a neutralizing agent and 430 g of ion-exchanged. The resulting reaction solution was mixed and stirred at a temperature of not lower than 10° C. and not higher than 15° C. using a disper blade at 1,500 r/min for 15 minutes.

Successively, 100 g of C.I. Pigment Red 150 (PR 150; azo-based pigment) available from Fuji Pigment Co., Ltd., was added to the reaction solution obtained above, and the resulting mixture was mixed and stirred at a temperature of not lower than 10° C. and not higher than 15° C. using a disper blade at 6,500 r/min for 2 hours.

The resulting preliminary dispersion was subjected to filtration treatment by passing through a 200-mesh filter, and then mixed and diluted with 36.1 g of ion-exchanged water. The thus obtained diluted dispersion was subjected to dispersion treatment under a pressure of 150 MPa by passing through a Microfluidizer “M-110EH-30XP” (high-pressure homogenizer) available from Microfluidics Corporation 15 times, thereby obtaining a pigment dispersion liquid of pigment-containing polymer particles a-1.
(2) Step 2

A 2 L eggplant-shaped flask was charged with a whole amount of the pigment dispersion liquid obtained in the step 1, and then ion-exchanged water was added thereto such that a solid content of the dispersion was controlled to 15% by mass. The resulting dispersion was maintained under a pressure of 0.09 MPa (abs) in a warm water bath adjusted at 32° C. for 3 hours using a rotary distillation apparatus “Rotary Evaporator N-1000S” available from Tokyo Rikakikai Co., Ltd., operated at a rotating speed of 50 r/min to thereby remove the organic solvent therefrom. Furthermore, the temperature of the warm water bath was adjusted to 62° C., and the pressure was reduced to 0.07 MPa (abs), and the reaction solution was concentrated under this condition until a solid content of the reaction solution was increased to 25% by mass, thereby obtaining a concentrated solution.

The thus obtained concentrated solution was charged into a 500 mL angle rotor, and subjected to centrifugal separation using a high-speed cooling centrifuge “himac CR22G” (temperature set: 20° C.) available from Hitachi Koki Co., Ltd., at 3,660 r/min for 20 minutes. Thereafter, the thus separated liquid layer portion was subjected to filtration treatment by passing through a membrane filter “Minisart” having a pore size of 5 gm available from Sartorius Inc., thereby obtaining a water dispersion of pigment-containing polyester particles A-1.

The average particle size of the pigment-containing polyester particles A-1 was 161 nm.

### Preparation Example A2 (Preparation of Water Dispersion A-II of Pigment-Containing Polyester Particles A-2 as Contaminants)

The same procedure as in Preparation Example Al was repeated except that the polyester PA-1 was replaced with the polyester PA-2 to obtain a pigment dispersion liquid of pigment-containing polymer particles a-2, thereby obtaining a water dispersion A-II of pigment-containing polyester particles A-2. The average particle size of the pigment-containing polyester particles A-2 was 159 nm.

### Production Examples B1 and B2 (Production of Water-Insoluble Vinyl Polymers PB-1 and PB-2)

The monomers, solvent and polymerization chain transfer agent shown in the column “Initially Charged Monomer Solution” in Table 1 or 2 were charged into a reaction vessel equipped with two dropping funnels 1 and 2 and mixed with each other, and an inside atmosphere of the reaction vessel was replaced with nitrogen gas, thereby obtaining an initially charged monomer solution.

On the other hand, the monomers, solvent, polymerization initiator and polymerization chain transfer agent shown in the column “Dropping Monomer Solution 1” in Table 1 or 2 were mixed with each other to obtain a dropping monomer solution 1. The thus obtained dropping monomer solution 1 was charged into the dropping funnel 1, and an inside atmosphere of the dropping funnel 1 was replaced with nitrogen gas.

Also, the monomers, solvent, polymerization initiator and polymerization chain transfer agent shown in the column “Dropping Monomer Solution 2” in Table 1 or 2 were mixed with each other to obtain a dropping monomer solution 2. The thus obtained dropping monomer solution 2 was charged into the dropping funnel 2, and an inside atmosphere of the dropping funnel 2 was replaced with nitrogen gas.

In a nitrogen atmosphere, the initially charged monomer solution in the reaction vessel was maintained at 77° C. while stirring, and the dropping monomer solution 1 in the dropping funnel 1 was gradually added dropwise to the reaction vessel over 3 hours. Next, the dropping monomer solution 2 in the dropping funnel 2 was gradually added dropwise to the reaction vessel over 2 hours. After completion of the dropwise addition, the mixed solution in the reaction vessel was stirred at 77° C. for 0.5 hour. Then, a polymerization initiator solution prepared by dissolving 0.6 part of a polymerization initiator 2, 2′-azobis(2, 4-dimethylvaleronitrile) “V-65” (tradename) available from FUJIFILM Wako Pure Chemical Corporation in 27.0 parts of methyl ethyl ketone was added to the mixed solution, and the resulting reaction solution was aged at 77° C. for 1 hour while stirring. The aforementioned procedure including the preparation and addition of the polymerization initiator solution and the aging of the reaction solution was repeated five more times. Then, while maintaining the reaction solution in the reaction vessel at 80° C. for 1 hour, methyl ethyl ketone was added thereto, thereby obtaining a solution of a water-insoluble polymer PB-1 (solid content: 40.8%).

The weight-average molecular weight of the resulting water-insoluble vinyl polymer PB-1 (as shown in Table 1) was 52,700, and the weight-average molecular weight of the resulting water-insoluble vinyl polymer PB-2 (as shown 5 in Table 2) was 170,000.

Meanwhile, the details of the respective monomers shown in Tables 1 and 2 were as follows.

Styrene macromer: “AS-6(S)” (active ingredient content: 50%; 10 number-average molecular weight: 6000) available from Toagosei Co., Ltd.

TM-40G: Methoxy polyethylene glycol monomethacrylate “NK ESTER TM-40G” (average molar number of addition of ethyleneoxide: 4; end group: methoxy group) available from Shin-Nakamura Chemical Co., Ltd.

PP-800: Polypropylene glycol monomethacrylate “BLEMMER PP-800” 15 (average molar number of addition of propyleneoxide: 12; end group: hydroxy group) available from NOF Corporation.

43PAPE-600B: Polyethylene glycol/polypropylene glycol monomethacrylate “BLEMMER 43PAPE-600B” (tradename; average molar number of addition of ethyleneoxide: 6; average molar number of addition of 20 propyleneoxide: 6; end group: phenyl group) available from NOF Corporation.

TABLE 1
Water-Insoluble Polymer PB-1

| | | Initially charged | Dropping | Dropping |
|---|---|---|---|---|
| | | monomer solution | monomer solution | monomer solution |
| | | (part(s)) | 1 (part(s)) | 2 (part(s)) |
| (a) Ionic monomer | Methacrylic acid | — | 51.2 | 12.8 |
| (b) Hydrophobic | Styrene | 17.6 | 140.8 | 17.6 |
| monomer | Styrene macromer | 12.0 | 108.0 | — |
| (c) Hydrophilic | TM-40G | 10.0 | 80.0 | 10.0 |
| nonionic monomer | | | | |
| Solvent | Methyl ethyl ketone | 6.0 | 66.0 | 48.0 |
| Polymerization | V-65 | — | 3.2 | 0.8 |
| initiator | | | | |
| Polymerization | 2-Mercaptoethanol | 0.08 | 0.56 | 0.16 |
| chain transfer agent | | | | |

TABLE 2
Water-Insoluble Polymer PB-2

| | | Initially charged | Dropping | Dropping |
|---|---|---|---|---|
| | | monomer solution | monomer solution | monomer solution |
| | | (part(s)) | 1 (part(s)) | 2 (part(s)) |
| (a) Ionic monomer | Methacrylic acid | — | 35.2 | 8.8 |
| (b) Hydrophobic | Styrene | 4.0 | 32.0 | 4.0 |
| monomer | Benzyl methacrylate | 15.9 | 127.3 | 15.9 |
| | Styrene macromer | 8.0 | 72.0 | — |
| (c) Hydrophilic | PP-800 | 6.1 | 48.8 | 6.1 |
| nonionic monomer | 43PAPE-600B | 6.1 | 48.8 | 6.1 |
| Solvent | Methyl ethyl ketone | 6.0 | 66.0 | 48.0 |
| Polymerization | V-65 | — | 3.2 | 0.8 |
| initiator | | | | |
| Polymerization | 2-Mercaptoethanol | 0.08 | 0.56 | 0.16 |
| chain transfer agent | | | | |

### Preparation Example B1 (Preparation of Pigment Water Dispersion B-I of Pigment-Containing Vinyl Polymer Particles B-1 as Contaminants)

The same procedure as in Preparation Example Al was repeated except that the polyester PA-1 was replaced with the vinyl polymer PB-1, and C.I. Pigment Red 150 was replaced with C.I. Pigment Blue 15:3 (PB 15:3) available from Dai-Nichi Seika Color & Chemicals Mfg. Co., Ltd., thereby obtaining a pigment water dispersion B-I of pigment-containing vinyl polymer particles B-1. The average particle size of the pigment-containing vinyl polymer particles B-1 was 114 nm.

### Preparation Example B2 (Preparation of Pigment Water Dispersion B-II of Pigment-Containing Vinyl Polymer Particles B-2 as Contaminants)

The same procedure as in Preparation Example B1 was repeated except that the vinyl polymer PB-1 was replaced with the vinyl polymer PB-2, thereby obtaining a pigment water dispersion B-II of pigment-containing vinyl polymer particles B-2. The average particle size of the pigment-containing polyester particles B-2 was 119 nm.

### Preparation Example C1 (Preparation of Test Piece Contaminated with Pigment Water Dispersion)

A surface-polished plate material formed of SUS 304 (50 mm×25 mm×3 mm) was prepared as a test piece with a string guide hole.

A 250 mL heat-resistant glass bottle was charged with 150 g of the pigment dispersion liquid of the pigment-containing polymer particles a-1 (before being concentrated) containing the polyester PA-1 obtained in the step 1 of Preparation Example A1, and then the test piece was suspended with a string such that 70% of a lower portion of the test piece was dipped in the pigment dispersion liquid, but was kept in non-contact with an inner wall surface of the glass bottle. Thereafter, the pigment dispersion liquid was stirred with a stirrer tip at room temperature for 1 hour, thereby obtaining a test piece C-1 contaminated with the pigment water dispersion.

### Preparation Example C2 (Preparation of Test Piece Contaminated with Pigment Water Dispersion)

The same procedure as in Preparation Example Cl was repeated except that the “pigment dispersion liquid of the pigment-containing polymer particles a-1” was changed to the “pigment dispersion liquid of the pigment-containing polymer particles a-2 (before being concentrated) containing the polyester PA-2 obtained in Preparation Example A2”, thereby obtaining a test piece C-2 contaminated with the pigment water dispersion.

### Preparation Example C3 (Preparation of Test Piece Contaminated with Pigment Water Dispersion)

A 400 mL heat-resistant glass bottle was charged with 240 g of the pigment water dispersion B-1 containing the polymer PB-1 obtained in Preparation Example B1, 15 g of ion-exchanged water and 3.05 g of a crosslinking agent “DENACOL EX321L” (tradename; trimethylolpropane polyglycidyl ether; epoxy equivalent: 130) available from Nagase ChemteX Corporation, and then the test piece was suspended with a string such that 70% of a lower portion of the test piece was dipped in the resulting dispersion in the glass bottle, but was kept in non-contact with an inner wall surface of the glass bottle. Thereafter, the dispersion in the glass bottle was stirred with a stirrer tip for 1 hour while heating the dispersion to 90° C., followed by cooling the dispersion, thereby obtaining a test piece C-3 contaminated with the pigment water dispersion.

### Preparation Example C4 (Preparation of Test Piece Contaminated with Pigment Water Dispersion)

The same procedure as in Preparation Example C3 was repeated except that the pigment water dispersion B-I was changed to the pigment water dispersion B-II containing the polyester PB-2 obtained in Preparation Example B2, thereby obtaining a test piece C-4 contaminated with the pigment water dispersion.

### Examples 1 to 15 and Comparative Examples 1 to 7

The water-soluble organic amine (a), etc., the amine oxide (b) and the organic solvent (c) were mixed in compounding ratios shown in Table 3, and then ion-exchanged water was added to the resulting mixture such that a whole amount of the mixture was 200 g, thereby obtaining a cleaning agent composition.

Meanwhile, in Comparative Example 1, a 5N NaOH aqueous solution was added such that the pH value of the cleaning agent composition was 11 to 12 (amount added: 1%).

In Table 3, the unit of the HSP value is (J/cm³) ^{1/2}, and [−] shown in the column “Properties of cleaning agent composition” indicates that the properties of the cleaning agent composition were not measured.

The resulting cleaning agent composition was charged into a 250 mL heat-resistant glass bottle, and then the respective contaminated test pieces C-1 to C-4 obtained in Preparation Examples C1 to C4 were suspended with a string and set in the glass bottle such that a whole portion of the test piece was completely dipped in the cleaning agent composition, but the test piece was kept in non-contact with an inner wall surface of the glass bottle. The respective test pieces were cleaned while stirring the cleaning agent composition with a stirrer tip at room temperature (25° C.) for 1 hour. Then, the respective cleaned test pieces were obtained.

The resulting cleaned test pieces were visually observed to evaluate the degree of removal of contaminants therefrom according to the following evaluation ratings. The results are shown in Table 3.

### (Evaluation Ratings)

5: The same metallic luster as observed before being contaminated was recognized in not less than 90% region of the contaminated area of the test piece, and the remaining region was also thinned in its tint as compared to that before being cleaned.

4: The same metallic luster as observed before being contaminated was recognized in not less than 60% and less than 90% region of the contaminated area of the test piece, and the remaining region was also thinned in its tint as compared to that before being cleaned.

3: The same metallic luster as observed before being contaminated was recognized in not less than 30% and less than 60% region of the contaminated area of the test piece, and the remaining region was also thinned in its tint as compared to that before being cleaned.

2: The same metallic luster as observed before being contaminated was recognized in less than 30% region of the contaminated area of the test piece, and the remaining region was also thinned in its tint as compared to that before being cleaned.

1: The same metallic luster as observed before being contaminated was recognized in less than 30% region of the contaminated area of the test piece, and the contamination exhibiting the same density as that before being cleaned was recognized in some portion of the remaining region.

TABLE 3-1

| | Cleaning agent composition | | | | | | | |
|---|---|---|---|---|---|---|---|---|
| | Water-soluble organic | | | | Organic solvent (c) | | | |
| | amine (a), etc. | | Amine oxide (b) | | Kind | | Mass ratio | |
| Examples | Kind | (%) | Kind | (%) | (HSP value) | (%) | (a)/(b) | (c)/(b) |
| 1 | Monoethanol amine | 3.3 | Lauryl dimethylamine oxide | 0.75 | MEK (19.05) | 20 | 4.4 | 27 |
| 2 | Monoethanol amine | 3.3 | Lauryl dimethylamine oxide | 0.75 | MEK (19.05) | 20 | 4.4 | 27 |
| 3 | Monoethanol amine | 3.3 | Lauryl dimethylamine oxide | 1.00 | MEK (19.05) | 20 | 3.3 | 20 |
| 4 | Monoethanol amine | 3.3 | Lauryl dimethylamine oxide | 0.10 | MEK (19.05) | 20 | 33 | 200 |
| 5 | Monoethanol amine | 3.3 | Lauryl dimethylamine oxide | 0.08 | MEK (19.05) | 20 | 44 | 266 |
| 6 | Monoethanol amine | 0.3 | Lauryl dimethylamine oxide | 0.75 | MEK (19.05) | 20 | 0.4 | 27 |
| 7 | Monoethanol amine | 0.3 | Lauryl dimethylamine oxide | 0.08 | MEK (19.05) | 20 | 3.75 | 266 |
| 8 | Monoethanol amine | 4.4 | Lauryl dimethylamine oxide | 1.0 | MEK (19.05) | 20 | 4.4 | 20 |
| 9 | Diethanol amine | 3.3 | Lauryl dimethylamine oxide | 0.75 | MEK (19.05) | 20 | 4.4 | 27 |
| 10 | Triethanol amine | 3.3 | Lauryl dimethylamine oxide | 0.75 | MEK (19.05) | 20 | 4.4 | 27 |
| 11 | Monoethanol amine | 3.3 | Lauryl dimethylamine oxide | 0.75 | MIBK (16.97) | 20 | 4.4 | 27 |
| 12 | Monoethanol amine | 3.3 | Lauryl dimethylamine oxide | 0.75 | THF (19.46) | 20 | 4.4 | 27 |
| 13 | Monoethanol amine | 3.3 | Lauryl dimethylamine oxide | 0.75 | EtOAc (18.15) | 20 | 4.4 | 27 |
| 14 | Monoethanol amine | 3.3 | Lauryl dimethylamine oxide | 0.75 | MEK (19.05) | 20 | 4.4 | 27 |
| 15 | Monoethanol amine | 3.3 | Lauryl dimethylamine oxide | 0.75 | MEK (19.05) | 20 | 4.4 | 27 |

Note:
* MEK: methyl ethyl ketone; MIBK: methyl isobutyl ketone; THF: tetrahydrofuran; EtOAc: Ethyl acetate

TABLE 3-2

| | Properties of cleaning agent composition | | | | Evaluation of cleaning properties | |
|---|---|---|---|---|---|---|
| | | | Surface | Test | Target polymer | Evaluation |
| | | Viscosity | tension | piece | to be removed | by visual |
| Examples | pH | (mPa · s) | (mN/m) | Kind | by cleaning | observation |
| 1 | 11.7 | 1.3 | 28.9 | C-1 | PA-1 | 5 |
| 2 | 11.7 | 1.3 | 28.9 | C-2 | PA-2 | 5 |
| 3 | — | — | — | C-2 | PA-2 | 5 |
| 4 | — | — | — | C-2 | PA-2 | 4 |
| 5 | — | — | — | C-2 | PA-2 | 4 |
| 6 | — | — | — | C-2 | PA-2 | 4 |
| 7 | — | — | — | C-2 | PA-2 | 4 |
| 8 | — | — | — | C-2 | PA-2 | 5 |
| 9 | 10.8 | 1.3 | 28.8 | C-2 | PA-2 | 5 |
| 10 | 9.8 | 1.3 | 29.0 | C-2 | PA-2 | 4 |
| 11 | 11.5 | 1.3 | 23.5 | C-2 | PA-2 | 5 |
| 12 | 11.6 | 1.4 | 30.7 | C-2 | PA-2 | 4 |
| 13 | 11.6 | 1.3 | 26.8 | C-2 | PA-2 | 5 |
| 14 | 11.7 | 1.3 | 28.9 | C-3 | PB-1 | 5 |
| 15 | 11.7 | 1.3 | 28.9 | C-4 | PB-2 | 4 |

TABLE 3-3

| | Cleaning agent composition | | | | | | | |
|---|---|---|---|---|---|---|---|---|
| | Water-soluble organic | | | | Organic solvent (c) | | | |
| Comparative | amine (a), etc. | | Amine oxide (b) | | Kind | | Mass ratio | |
| Examples | Kind | (%) | Kind | (%) | (HSP value) | (%) | (a)/(b) | (c)/(b) |
| 1 | 5N NaOH | 1.0 | Lauryl dimethylamine oxide | 0.75 | MEK (19.05) | 20 | — | — |
| 2 | Monoethanol amine | 3.3 | — | — | MEK (19.05) | 20 | — | — |
| 3 | — | — | Lauryl dimethylamine oxide | 0.75 | MEK (19.05) | 20 | — | — |
| 4 | Monoethanol amine | 3.3 | Lauryl dimethylamine oxide | 0.75 | Acetone (19.94) | 20 | 4.4 | 27 |
| 5 | Monoethanol amine | 3.3 | Lauryl dimethylamine oxide | 0.75 | ETOH (26.52) | 20 | 4.4 | 27 |
| 6 | Monoethanol amine | 3.3 | Lauryl dimethylamine oxide | 0.75 | BDG (20.42) | 20 | 4.4 | 27 |
| 7 | Monoethanol amine | 3.3 | Lauryl dimethylamine oxide | 0.75 | DMF (24.86) | 20 | 4.4 | 27 |

Note *:
ETOH: ethanol;
BDG: butyl diglycol;
DMF: N,N-dimethylformamide

TABLE 3-4

| | Properties of cleaning agent composition | | | | Evaluation of cleaning properties | |
|---|---|---|---|---|---|---|
| | | | Surface | Test | Target polymer | Evaluation |
| Comparative | | Viscosity | tension | piece | to be removed | by visual |
| Examples | pH | (mPa · s) | (mN/m) | Kind | by cleaning | observation |
| 1 | — | — | — | C-2 | PA-2 | 3 |
| 2 | — | — | — | C-2 | PA-2 | 3 |
| 3 | — | — | — | C-2 | PA-2 | 1 |
| 4 | 11.4 | 1.2 | 31.8 | C-2 | PA-2 | 2 |
| 5 | 11.6 | 1.6 | 30.3 | C-2 | PA-2 | 1 |
| 6 | 11.6 | 1.9 | 31.2 | C-2 | PA-2 | 2 |
| 7 | 11.3 | 1.5 | 32.6 | C-2 | PA-2 | 1 |

From Table 3, it was confirmed that in accordance with the present invention, it was possible to effectively clean the hard surface to which polymers, etc., were adhered.

### Example 16

In a 1000 L-capacity container formed of SUS 304, 33.35 kg of the polyester PA-2 obtained in Production Example A2 was dissolved in 78.2 kg of MEK. The obtained solution was mixed with 2.68 kg of a 5N sodium hydroxide aqueous solution as a neutralizing agent and 215 kg of ion-exchanged water. The resulting reaction solution was mixed while stirring at a temperature of not lower than 10° C. and not higher than 15° C. using a disper blade at 500 r/min for 15 minutes.

Successively, 50 kg of C.I. Pigment Red 150 (PR 150; azo-based pigment) available from Fuji Pigment Co., Ltd., was added to the reaction solution, and the resulting mixture was mixed while stirring at a temperature of not lower than 10° C. and not higher than 15° C. using a disper blade at 1,500 r/min for 4 hours. Thereafter, all of the contents of the container were discharged therefrom, and the container was allowed to stand at room temperature (25° C.) for 1 hour to prepare a contaminated reactor.

Eight hundred kilograms of the same cleaning agent composition as produced in Example 1 were poured like falls into the contaminated reactor to foam the cleaning agent composition therein. The reactor was substantially completely filled with the cleaning agent composition and foams generated therefrom. Thereafter, the contents of the reactor were mixed while stirring at room temperature using a disper blade at 200 r/min for 1 hour, and then all of the contents of the reactor were discharged therefrom, and the surface of the reactor thus cleaned was observed to determine a cleaning condition thereof. As a result, it was confirmed that the cleaning condition of the surface of the reactor as a whole corresponded to the evaluation rating 5, and therefore the cleaning agent composition exhibited excellent cleaning properties.

From the aforementioned results, it was recognized that in accordance with the present invention, the cleaning agent composition is capable of effectively cleaning the hard surface to which the polymers, etc., were adhered, under room temperature conditions irrespective of the sizes of the materials to be removed by cleaning.

### INDUSTRIAL APPLICABILITY

The cleaning agent composition of the present invention is capable of exhibiting excellent cleaning power against a hard surface to which polymers, etc., are adhered, even under room temperature conditions, and therefore is useful, in particular, for cleaning a hard surface constituting a production line for production of an ink for ink-jet printing.

1. A cleaning agent composition comprising a water-soluble organic amine (a), an alkylamine oxide (b) represented by the following general formula (1), an organic solvent (c) having a Hansen solubility parameter (HSP value) of not less than 15 and not more than 19.5 as measured at 20° C., and water:
(R¹)(R²)(R³)N→O (1)
wherein R¹ and R² are each independently an alkyl group or alkenyl group having not less than 1 and not more than 3 carbon atoms, and R³ is an alkyl group or alkenyl group having not less than 8 and not more than 16 carbon atoms.

2. The cleaning agent composition according to claim 1, wherein the water-soluble organic amine (a) is an alkanolamine.

3. The cleaning agent composition according to claim 2, wherein the alkanolamine is at least one compound selected from the group consisting of monoethanolamine, diethanolamine and N-methyl ethanolamine.

4. The cleaning agent composition according to claim 1, wherein the alkylamine oxide (b) is at least one compound selected from the group consisting of lauryl dimethylamine oxide, lauryl diethylamine oxide, myristyl dimethylamine oxide and cocoalkylamine oxide.

5. The cleaning agent composition according to claim 1, wherein the organic solvent (c) is at least one compound selected from the group consisting of an ether group-containing compound, an ester group-containing compound and a ketone group-containing compound.

6. The cleaning agent composition according to claim 1, wherein the organic solvent (c) is at least one compound selected from the group consisting of tetrahydrofuran, diethyl ether, ethyl acetate, isopropyl acetate, propyl acetate, butyl acetate, methyl ethyl ketone, methyl propyl ketone, methyl isobutyl ketone and diisobutyl ketone.

7. The cleaning agent composition according to claim 1, wherein a mass ratio of the water-soluble organic amine (a) to the alkylamine oxide (b) [(a)/(b)] is not less than 0.1 and not more than 50.

8. The cleaning agent composition according to claim 7, wherein the mass ratio of the water-soluble organic amine (a) to the alkylamine oxide (b) [(a)/(b)] is not less than 1 and not more than 20.

9. The cleaning agent composition according to claim 1, wherein a mass ratio of the organic solvent (c) to the alkylamine oxide (b) [(c)/(b)] is not less than 10 and not more than 300.

10. The cleaning agent composition according to claim 9, wherein the mass ratio of the organic solvent (c) to the alkylamine oxide (b) [(c)/(b)] is not less than 15 and not more than 250.

11. The cleaning agent composition according to claim 1, wherein a pH value of the cleaning agent composition is not less than 9.

12. A method of cleaning a hard surface, comprising the step of cleaning the hard surface using the cleaning agent composition according to claim 1 at a temperature of not lower than 0° C. and not higher than 50° C.

13. The method of cleaning a hard surface according to claim 12, wherein the hard surface is a surface of a metal member which is brought into contact with a polymer.

14. The method of cleaning a hard surface according to claim 12, wherein the hard surface is cleaned under the condition that the cleaning agent composition is kept in a foamed state.

15. (canceled)

16. (canceled)
